(19) United States
(12) Patent Application Publication
(10) Pub. No.: US 2006/0018359 A1
(43) Pub. Date: Jan. 26, 2006

(54) Structure for optical axis adjustment of laser diode and optical pickup apparatus

(76) Inventors: Akiho Yoshizawa, Higashihiroshima-shi (JP); Kenji Hatazawa, Osaka (JP)

Correspondence Address: MORRISON & FOERSTER LLP, 755 PAGE MILL RD, PALO ALTO, CA, 94304-1018, US

(21) Appl. No.: 11/187,791

(22) Filed: Jul. 22, 2005

(30) Foreign Application Priority Data
Jul. 23, 2004 (JP) P2004-216226

(51) Int. Cl. H01S 3/08

(52) U.S. Cl. 372/107

(57) ABSTRACT

A structure for optical axis adjustment of a laser diode is provided which makes it possible to easily perform optical axis adjustment and inclination adjustment of the optical axis and makes it possible to shorten the operation time necessary for the assembly of the apparatus. The structure for optical axis adjustment includes a housing; a base that is supported so as to be movable along one surface portion of the housing; a laser diode holder that is supported on the base so as to be tiltingly movable and supports a laser diode; and first and second pressing plates that press and movably support the base and the laser diode holder on the housing.

### BACKGROUND OF THE INVENTION

1. Field of the Invention

The present invention relates to a structure for optical axis adjustment of a laser diode which is applied as, for example, a light source of an optical pickup, and to an optical pickup apparatus.

In the invention, ‘substantially around’ includes ‘around,’ and ‘substantially along a virtual spherical surface’ includes ‘along a virtual spherical surface.’

2. Description of the Related Art

An optical pickup apparatus that records, reproduces and deletes information of a recording medium such as a compact disk (abbreviated to CD), a digital versatile disk (abbreviated to DVD) and a Blu-ray Disk (abbreviated to BD) is practically used. As a light source of the optical pickup apparatus, a laser diode is applied {refer to Japanese Unexamined Patent Publication No. JP-A 5-81693 (1993), for example}. FIG. 7 is a plan view illustrating the essential part of a conventional optical axis adjustment structure of an optical pickup apparatus, and FIG. 8 is a side view illustrating the essential part of the conventional optical axis adjustment structure of the optical pickup apparatus.

The optical pickup apparatus has a housing 1, a laser diode base 2, a pressing plate 3 made of a spring member, a laser diode holder 4, and a laser diode 5. To the laser diode holder 4, the laser diode 5 is firmly attached with an adhesive or the like. The laser diode holder 4 has a contact portion that is formed into a partially spherical shape (referred to as the spherical contact portion). The laser diode base 2 has a spherical pedestal that abuts against the spherical contact portion.

The laser diode holder 4 and the laser diode base 2 are fixed with four screws 6. By tightening and loosening the four screws 6, an inclination of the optical axis is adjusted. The laser diode base 2 is movably supported on the housing 1 by the pressing plate 3. Thus, the optical axis on the plane of the laser diode 5 is adjusted.

In the conventional optical axis adjustment structure, the optical axis adjustment on the plane and the inclination adjustment of the optical axis must be successively performed. Moreover, as to the inclination adjustment of the optical axis, the adjustment itself takes a lot of time for tightening and loosening of the screws 6. Therefore, in the conventional optical axis adjustment structure, it is impossible to easily perform the optical axis adjustment and the inclination adjustment of the optical axis, and moreover, the time for the assembly of the apparatus is long.

### SUMMARY OF THE INVENTION

An object of the invention is to provide a structure for optical axis adjustment of a laser diode that makes it possible to easily perform optical axis adjustment and inclination adjustment of the optical axis, and shortens operation time necessary for assembling the apparatus.

The invention provides a structure for optical axis adjustment of a laser diode, comprising a housing, laser diode supporting means capable of supporting a laser diode, and pressing means for pressing and movably retaining the laser diode supporting means on the housing.

According to the invention, a optical axis adjustment structure comprises a housing, laser diode supporting means, and pressing means. The laser diode supporting means is capable of supporting the laser diode. The pressing means presses and movably supports the laser diode supporting means on the housing. When the laser diode and the laser diode supporting means should be moved, that is, should be adjusted, the following operation is produced. The laser diode supporting means is pressed on the housing at all times due to the pressing force of the pressing means, and moreover, moves relatively to the housing. It is possible to move the laser diode supporting means with respect to the housing over a specified short distance, without an influence by the pressing force. The optical axis of the laser diode is adjusted in this way. In this way, it is possible to easily perform optical axis adjustment and inclination adjustment of the optical axis with a simpler structure than the conventional structure. Therefore, it is possible to make the operation time necessary for the assembly of the apparatus shorter than in the conventional art.

Further, in the invention, it is preferable that the laser diode supporting means includes a base that is supported so as to be movable along one surface portion of the housing, and a laser diode holder that is tiltingly movably supported on the base and supports the laser diode.

According to the invention, the laser diode supporting means includes a base and a laser diode holder. The base is supported so as to be movable along one surface portion of the housing. The laser diode holder is supported on the base so as to be tiltingly movable, and supports the laser diode. Optical axis adjustment of the laser diode and inclination adjustment of the optical axis are thereby performed. In particular, since the laser diode holder is tiltingly movably supported on the base, it is possible to easily perform the optical axis adjustment. It is possible to adjust the optical axis of the laser diode and adjust inclination of the optical axis in this way. It is possible to easily perform the optical axis adjustment and the inclination adjustment of the optical axis with such a simple structure.

Furthermore, in the invention, it is preferable that the laser diode holder has one curved portion that faces the base and the other curved portion that faces the pressing means, and the one curved portion and the other curved portion are formed substantially along a virtual spherical plane substantially around the light emitting point of the laser diode.

According to the invention, the laser diode holder has one curved portion and the other curved portion. The one curved portion and the other curved portion are formed substantially along a virtual spherical plane substantially around the light emitting point. The one curved portion faces the base, and the other curved portion faces the pressing means. The other curved portion is pressed and supported by the pressing means, and the one curved portion abuts against the base and tilts. In a state where the laser diode holder abuts against the base in this manner, the inclination adjustment of the optical axis of the laser diode can be performed, and moreover, it can be pressed with the pressing means in order to support the state after the inclination adjustment.

Still further, in the invention, it is preferable that the one curved portion and the other curved portion of the laser diode holder have different radiuses of curvature;

According to the invention, the radius of curvature of the one curved portion and the radius of curvature of the other curved portion are different, so that the following operation is produced. It is possible to fix the radius of curvature of the one curved portion that faces the base, and change the radius of curvature of the other curved portion that faces the pressing means in various manners, thereby forming the other curved portion into an optimum shape for the pressing means and the laser diode. On the contrary, it is possible to fix the radius of curvature of the other curved portion, and change the radius of curvature of the one curved portion in various manners, thereby forming the one curved portion into an optimum shape for the base. Accordingly, it is possible to shorten the time for a change of design, and it is possible to reduce the cost of manufacture.

Still further, in the invention, it is preferable that the other curved portion of the laser diode holder is formed so as to have a larger radius of curvature than that of the one curved portion.

According to the invention, the radius of curvature of the one curved portion of the laser diode holder that abuts against the base is made to be smaller than the radius of curvature of the other curved portion. Conversely, the other curved portion has a larger radius of curvature than that of the one curved portion. Besides, the radius of curvature of the other curved portion is determined on the basis of the size of the laser diode and so on. Since the other curved portion is formed so as to have a larger radius of curvature than that of the one curved portion, it is possible to make a movement amount when moving the laser diode holder relatively to the base large, at the time of the inclination adjustment of the optical axis. It is possible to make the amount of relative movement of the laser diode holder necessary for inclination angle adjustment of the optical axis large. Consequently, it is possible to easily and promptly perform minute inclination adjustment of the optical axis.

Still further, in the invention, it is preferable that an abutting surface of the base that faces the one curved portion of the laser diode holder is formed into a circular cone shape.

According to the invention, an abutting surface of the base that faces the one curved portion of the laser diode holder is formed into a circular cone shape, whereby the following operation is produced. It is possible to form a gap between the circular cone portion of the base and the one curved portion of the laser diode holder. By applying an adhesive to the gap and curing the adhesive, it is possible to firmly fix the laser diode holder to the base.

Still further, the invention provides a structure for optical axis adjustment of a laser diode, comprising a housing, a laser diode having a cap portion which is formed partially into a spherical shape, and pressing means for pressing and movably supporting the laser diode on the housing via the cap portion.

According to the invention, an optical axis adjustment structure comprises a housing, a laser diode, and pressing means. A cap portion of the laser diode is formed partially into a spherical shape. The pressing means presses and movably supports the laser diode on the housing via the cap portion. When the laser diode should be moved, that is, should be adjusted, the following operation is produced. The laser diode is pressed on the housing at all times due to the pressing force of the pressing means, and moreover, moves relatively to the housing via the cap portion. It is possible to move the laser diode with respect to the housing over a specified short distance, without an influence by the pressing force. The optical axis of the laser diode is adjusted in this way. In particular, since it is possible to relatively and directly move the laser diode with respect to the housing via the cap portion, it is possible to remarkably reduce the number of components less than in the conventional art. Besides, the same effects as in claim 1 are obtained.

In the invention, it is preferable that the pressing means includes a pressing plate which is made of a spring member that is elastically deformable.

Still further, the invention provides an optical pickup apparatus provided with the structure for optical axis adjustment of the laser diode described above.

According to the invention, it is possible to realize an optical pickup apparatus that is provided with the structure for optical axis adjustment of the laser diode described above. As to the laser diode installed in the optical pickup apparatus, it is possible to easily perform the optical axis adjustment and the inclination adjustment of the optical axis with a simpler structure than the conventional structure, and it is possible to shorten the operation time necessary for assembly. Thus, it is possible to shorten the time for the assembly of the whole optical pickup apparatus and the time for optical axis adjustment, and moreover, it is possible to realize an optical pickup apparatus whose quality is higher than that of a conventional one.

### BRIEF DESCRIPTION OF THE DRAWINGS

Other and further objects, features, and advantages of the invention will be more explicit from the following detailed description taken with reference to the drawings wherein:

FIG. 1 is a cross section view of the essential part of an optical pickup apparatus according to a first embodiment of the invention, taken on a virtual plane including an optical axis;

FIG. 2 is a plan view of the essential part of the optical pickup apparatus according to the first embodiment;

FIG. 3 is a side view showing the relation among a housing, laser diode supporting means, and pressing means;

FIG. 4 is a cross section view of the essential part of an optical pickup apparatus according to a second embodiment of the invention, taken on a virtual plane including the optical axis;

FIG. 5 is a cross section view illustrating, in a magnified manner, the essential part of a base whose abutting surface is formed into a circular cone shape;

FIG. 6 is a cross section view of the essential part of an optical pickup apparatus according to a third embodiment of the invention, taken on a virtual plane including the optical axis;

FIG. 7 is a plan view illustrating the essential part of a conventional structure for optical axis adjustment of an optical pickup apparatus; and

FIG. 8 is a side view illustrating the essential part of the conventional structure for optical axis adjustment of the optical pickup apparatus.

### DETAILED DESCRIPTION OF THE PREFERRED EMBODIMENTS

Now referring to the drawings, preferred embodiments of the invention are described below.

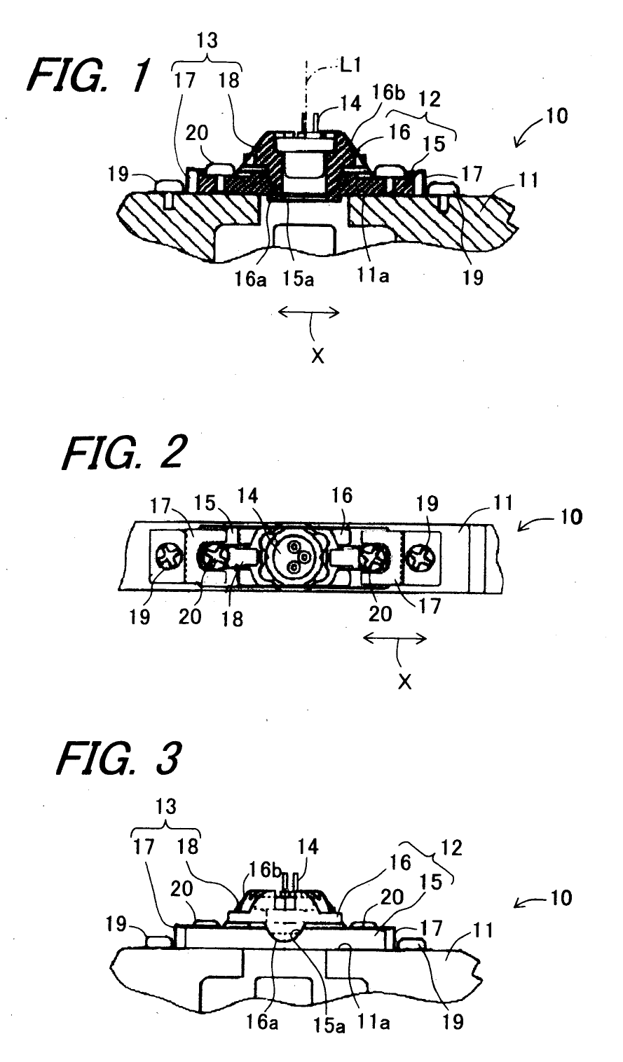

FIG. 1 is a cross section view of the essential part of an optical pickup apparatus 10 according to a first embodiment of the invention, taken on a virtual plane including an optical axis L1. FIG. 2 is a plan view of the essential part of the optical pickup apparatus 10 according to the first embodiment. FIG. 3 is a side view showing the relation among a housing 11, laser diode supporting means 12, and pressing means 13. The optical pickup apparatus 10 (referred to as the first pickup apparatus 10) according to the first embodiment is applied to an apparatus that irradiates a light of a laser diode to a recording medium such as a compact disk (abbreviated to CD), a digital versatile disk (abbreviated to DVD) and a Blu-ray Disk (abbreviated to BD), and records information on the recording surface thereof, or reproduces information written on the recording surface of the recording medium.

The first pickup apparatus 10 comprises a laser diode 14 serving as a light source, a structure for optical axis adjustment, an optical system, an actuator, and a light receiving element. The structure for optical axis adjustment for adjusting the optical axis L1 of the laser diode 14, and mainly has the housing 11, a laser diode holder base 15, a laser diode holder 16, and the pressing means 13 that includes first and second pressing plates 17, 18. The laser diode holder base 15 is synonymous with ‘the base.’

The housing 11 has a hole portion that is formed in order to ensure the path of a light from at least the laser diode 14. On the housing 11, along one surface portion 11a of the housing 11, the base 15 is movably supported by a pair of first pressing plates 17. The first pressing plates 17 are separately positioned at a specified distance in the x-direction expressed by an arrow x in FIGS. 1 and 2. Each of the first pressing plates 17 is made of a spring member that is capable of elastically deforming, one end portion thereof is fixed to the housing 11 with a screw 19, and the other end portion of each of the first pressing plates 17 presses and supports the base 15. A portion in the vicinity of the middle in the x-direction of each of the first pressing plates 17 is bent at a right angle with respect to the one end portion and the other end portion, by the thickness of the base 15.

The other end portion of the first pressing plate 17 is cut off in the x-direction, so that the other end portion does not interfere with a screw 20 for fixing the second pressing plate 18 described hereinafter. In other words, the base 15 is capable of moving along the one surface portion 11a of the housing 11 in a state where it is pressed and supported on the housing 11 by the other end portions of the pair of first pressing plates 17. The x-direction is synonymous with a direction that is perpendicular to the thickness direction of the first pickup apparatus 10 as well as along the one surface portion 11a. In the vicinity of the middle in the x-direction of the base 15, a base hole portion that communicates with the hole portion of the housing 11 is formed, and the light path is ensured.

The laser diode holder 16 that is supported on the base 15 so as to be tiltingly movable and supports the laser diode 14 is disposed. The base 15 and the laser diode holder 16 correspond to the laser diode supporting means. That is to say, it is possible to support the laser diode 14 with the base 15 and the laser diode holder 16. The laser diode holder 16 has a base-side spherical convex portion 16a that faces the base 15, and moreover, a pressing-plate-side spherical convex portion 16b that faces the second pressing plate 18. The base-side spherical convex portion 16a corresponds to the one curved portion, and the pressing-plate-side spherical convex portion 16b corresponds to the other curved portion. The base-side spherical convex portion 16a and the pressing-plate-side spherical convex portion 16b are formed substantially along a virtual spherical surface substantially around the light emitting point of the laser diode 14. The base-side spherical convex portion 16a and the pressing-plate-side spherical convex portion 16b are formed so as to have different radiuses of curvature. In concrete, the pressing-plate-side spherical convex portion 16b is formed so as to have a larger radius of curvature than that of the base-side spherical convex portion 16a.

The base 15 has a spherical concave portion 15a that abuts against the base-side spherical convex portion 16a. The base-side spherical convex portion 16a and the spherical concave portion 15a are formed so as to be slidable. To the base 15 integrated with the housing 11, a pair of second pressing plates 18 are fixed with the screws 20, respectively. The second pressing plates 18 are positioned each other so as to be isolated inside in the x-direction with respect to a pair of first pressing plates 17. Each of the second pressing plates 18 is made of a spring member that is capable of elastically deforming, one end portion thereof is fixed to the base 15 with the screw 20, and the other end portion thereof presses and supports the pressing-plate-side spherical convex portion 16b of the laser diode holder 16. Due to the pressing force of the second pressing plates 18, the laser diode holder 16 is supported on the housing 11 so as to be tiltingly movable and the base 15 so as to be capable of tilting.

At the time of the optical axis adjustment of the laser diode 14 along the one surface portion 11a, the laser diode holder 16 is grasped with a catcher (not shown) of an optical axis adjustment machine, and the base 15, the second pressing plates 18, the laser diode holder 16 and the laser diode 14 move relatively to the housing 11 in a state where they are supported on the housing 11 by the first pressing plates 17. At the time of the inclination adjustment of the optical axis L1 of the laser diode 14, a rotation force around the light emitting point of the laser diode 14 is given with the catcher of the optical axis adjustment machine in the above state (the state right after the optical axis adjustment described above). In a state where the laser diode holder 16 and the laser diode 14 are supported on the base 15, that is, on the housing 11 by the second pressing plates 18, the base-side spherical convex portion 16a of the laser diode holder 16 and the spherical concave portion 15a of the base 15 slide. Thus; the inclination of the optical axis L1 of the laser diode 14 is adjusted. After the adjustments finish, even if the grasp with the catcher is loosened, the laser diode holder 16 and the base 15 are supported in the position after the adjustments by the first and second pressing plates 17, 18. In a state where the position after the adjustments is supported, it is possible to shift to an adhesion process as a post-process. In the adhesion process, the laser diode holder 16 is firmly fixed to the base 15 with an adhesive.

According to the structure for optical axis adjustment described above, the first and second pressing plates 17, 18 press and movably support the laser diode supporting means 12 on the housing 11. When the laser diode 14 and the laser diode supporting means 12 should be moved, that is, should be adjusted, the following operation and effect are produced. The laser diode supporting means 12 is pressed on the housing 11 at all times due to the pressing force of the first and second pressing plates 17, 18, and moreover, moves relatively to the housing 11. It is possible to move the laser diode supporting means 12 with respect to the housing 11 over a specified short distance, without an influence by the pressing force. Thus, it is possible to easily perform the optical axis adjustment and the inclination adjustment of the optical axis of the laser diode 14 with a simpler structure than the conventional structure. Therefore, it is possible to make the operation time necessary for the assembly of the apparatus shorter than in the conventional art.

Further, the base-side spherical convex portion 16a of the laser diode holder 16 faces the base 15, and the pressing-plate-side spherical convex portion 16b on the opposite side thereof faces the second pressing plate 18. The pressing-plate-side spherical convex portion 16b is pressed and supported by the second pressing plate 18, and the base-side spherical convex portion 16a abuts against the spherical concave portion 15a of the base 15 and tilts. In a state where the laser diode holder 16 abuts against the base 15, the inclination adjustment of the optical axis L1 of the laser diode 14 can be performed, and moreover, it can be pressed with the pressing means in order to support the state after the inclination adjustment.

In the laser diode holder 16, the radius of curvature of the base-side spherical convex portion 16a and the radius of curvature of the pressing-plate-side spherical convex portion 16b are different, so that the following effect is produced. It is possible to fix the radius of curvature of the base-side spherical convex portion 16a that faces the base 15, and change the radius of curvature of the pressing-plate-side spherical convex portion 16b that faces the second pressing plate 18 in various manners, thereby making one spherical shape optimum for the base 15. Therefore, a change of design is easy. Accordingly, it is possible to shorten the time for a change of design, and reduce the cost of manufacture. In a case where the radius of curvature of the pressing-plate-side spherical convex portion 16b is made to be larger than the radius of curvature of the base-side spherical convex portion 16a, it is possible to make a movement amount when moving the laser diode holder 16 relatively to the base 15 large, at the time of the inclination adjustment of the optical axis L1. It is possible to make a relative movement amount of the laser diode holder 16 necessary for the inclination angle adjustment of the optical axis L1 large. Consequently, it is possible to perform minute inclination adjustment of the optical axis L1 easily and promptly.

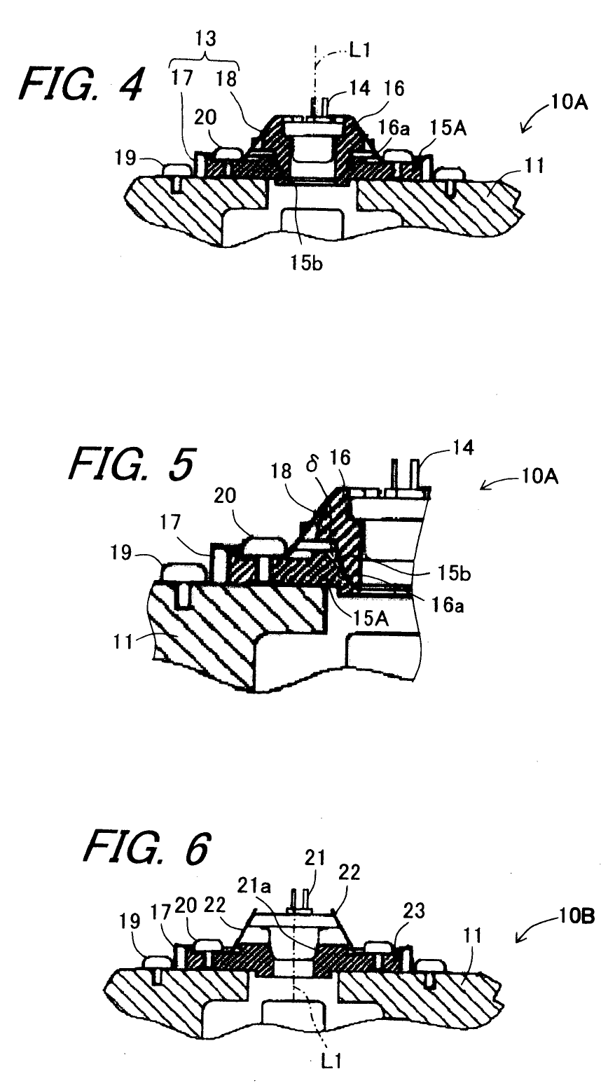

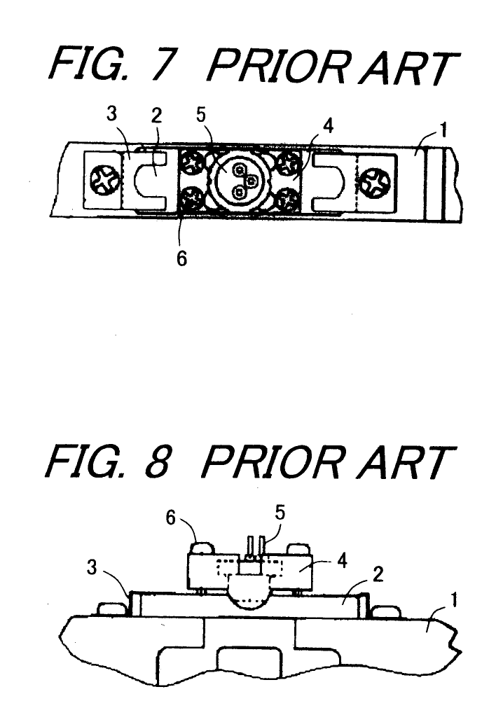

FIG. 4 is a cross section view of the essential part of an optical pickup apparatus 10A according to a second embodiment of the invention, taken on a virtual plane including the optical axis L1. FIG. 5 is a cross section view illustrating, in a magnified manner, the essential part of a base 15A whose abutting surface is formed into a circular cone shape. The same members as in the first embodiment will be denoted by the same reference numerals, and the detailed description thereof will be omitted. In the structure for optical axis adjustment of the optical pickup apparatus 10A of the second embodiment, the abutting surface of the base 15A that faces the base-side spherical convex portion 16a of the laser diode holder 16 is formed into a circular cone shape. Consequently, it is possible to form a gap δ between a circular cone portion 15b of the base 15A and the base-side spherical convex portion 16a of the laser diode holder 16. By filling up an adhesive to the gap δ and curing, it is possible to firmly fix the laser diode holder 16 to the base 15A.

FIG. 6 is a cross section view of the essential part of an optical pickup apparatus 10B according to a third embodiment of the invention, taken on a virtual plane including the optical axis L1. In the optical pickup apparatus 10B according to the third embodiment, a structure for optical axis adjustment of a laser diode 21 has the housing 11, the laser diode 21, a laser diode holder 23, and the first pressing plate 17 and a third pressing plate 22 that serve as the pressing means. A cap portion 21a of the laser diode 21 is formed into a partially spherical shape. The third pressing plate 22 presses and movably supports the laser diode 21 on the laser diode holder 23 integrated with the housing 11, via the cap portion 21a. When the laser diode 21 should be moved, that is, should be adjusted, the following operation and effect are produced. The laser diode 21 is pressed on the housing 11 at all times due to the pressing force of the third pressing plate 22, and moreover, moves relatively to the housing 11 via the cap portion 21a. It is possible to move the laser diode 21 with respect to the housing 11 over a specified short distance, without an influence by the pressing force. The optical axis of the laser diode 21 is adjusted in this way. In particular, since it is possible to move the laser diode 21 relatively and directly with respect to the housing 11 via the cap portion 21a, it is possible to make the component count less than in the conventional art. Besides, the same effects as in the first embodiment are produced.

As another embodiment of the invention, the base-side spherical convex portion and the pressing-plate-side spherical convex portion may be formed so as to have the same radius of curvature. It is also possible to make the radius of curvature of the base-side spherical convex portion larger than the radius of curvature of the pressing-plate-side spherical convex portion, on the contrary to the first embodiment.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A structure for optical axis adjustment of a laser diode, comprising:
a housing;
laser diode supporting means capable of supporting a laser diode; and
pressing means for pressing and movably retaining the laser diode supporting means on the housing.

2. The structure for optical axis adjustment of the laser diode of claim 1, wherein the laser diode supporting means includes a base that is supported so as to be movable along one surface portion of the housing, and a laser diode holder that is tiltingly movably supported on the base and supports the laser diode.

3. The structure for optical axis adjustment of the laser diode of claim 2, wherein the laser diode holder has one curved portion that faces the base and the other curved portion that faces the pressing means, and the one curved portion and the other curved portion are formed substantially along a virtual spherical plane substantially around the light emitting point of the laser diode.

4. The structure for optical axis adjustment of the laser diode of claim 3, wherein the one curved portion and the other curved portion of the laser diode holder have different radiuses of curvature.

5. The structure for optical axis adjustment of the laser diode of claim 3, wherein the other curved portion of the laser diode holder is formed so as to have a larger radius of curvature than that of the one curved portion.

6. The structure for optical axis adjustment of the laser diode of claim 3, wherein an abutting surface of the base that faces the one curved portion of the laser diode holder is formed into a circular cone shape.

7. The structure for optical axis adjustment of the laser diode of claim 1, wherein the pressing means includes a pressing plate which is made of a spring member that is elastically deformable.

8. An optical pickup apparatus provided with the structure for optical axis adjustment of the laser diode of claim 1.

9. A structure for optical axis adjustment of a laser diode, comprising:
a housing;
a laser diode having a cap portion which is formed partially into a spherical shape; and
pressing means for pressing and movably supporting the laser diode on the housing via the cap portion.

10. The structure for optical axis adjustment of the laser diode of claim 9, wherein the pressing means includes a pressing plate which is made of a spring member that is elastically deformable.

11. An optical pickup apparatus provided with the structure for optical axis adjustment of the laser diode of claim 9.
